(19) United States
(12) Patent Application Publication
(10) Pub. No.: US 2005/0026598 A1
(43) Pub. Date: Feb. 3, 2005

(54) System and method for notifying callers

(76) Inventors: Swetal A. Patel, Plantation, FL (US); Carlos J. Melendez, Port St. Lucie, FL (US); Amit Ramani, Coral Springs, FL (US)

Correspondence Address: Larry G. Brown;Motorola, Inc., Law Department, 8000 West Sunrise Boulevard, Fort Lauderdale, FL, 33322, US

(21) Appl. No.: 10/631,234

(22) Filed: Jul. 31, 2003

(51) Int. Cl. H04Q 7/20

(52) U.S. Cl. 455/412.2

(57) ABSTRACT

A method (300) for notifying callers. The method (300) can include the steps of assigning (322) a first communications channel (148) to a set of callers (137), temporarily converting (324) the first communications channel (148) to a second communications channel (150) when the first communications channel (148) is released and transmitting (336) a message to at least one of the set of callers (137) over the second communications channel (150). In one arrangement, the first communications channel (148) can be converted to the second communications channel (150) for the shorter duration of a predetermined amount of time and a time until the first communications channel (148) is no longer released.

### CROSS REFERENCE TO RELATED APPLICATIONS

(Not Applicable)

### BACKGROUND

1. Technical Field

This invention relates in general to telecommunications systems and more particularly, to telecommunications systems that support dispatch service.

2. Description of the Related Art

Many mobile communications units support dual communication modes. In particular, a dual communication mode mobile unit can support both cellular telephone service (sometimes referred to as interconnect service) and trunked dispatch service. When a user is placing a cellular telephone call, the user's mobile communications unit can receive and display a notification that another party is attempting to reach the user. This feature, commonly referred to as call waiting, can permit the user engaged in the cellular call to either answer the incoming call or ignore the incoming call and remain on the original call.

In interconnect service, the connection between callers is a full-duplex signal, which enables users to both receive and transmit simultaneously. Thus, for the interconnect call waiting feature, a complete circuit-switched connection is established for the third party who is trying to reach a caller engaged in another call. This connection allows callers to learn of and answer incoming calls that they would have otherwise missed.

For the trucked dispatch service, however, a half-duplex, packet-switched channel is shared by all the participants of a dispatch call. As a consequence, if a party is attempting to reach a caller engaged in a dispatch call, the incoming call cannot be set up; the original call must be completed and the connection terminated before the dispatch caller can be reached. In view of this shortcoming, no system has been developed for informing dispatch callers of incoming calls during a dispatch call. As a result, during a dispatch call, a party to the call has no way of knowing if another caller is trying to reach him or her until the dispatch call is completed.

### SUMMARY OF THE INVENTION

The present invention concerns a method for notifying callers. The method includes the steps of assigning a first communications channel to a set of callers, temporarily converting the first communications channel to a second communications channel when the first communications channel is released and transmitting a message to at least one of the set of callers over the second communications channel. In one arrangement, the first communications channel can be converted to the second communications channel for the shorter duration of a predetermined amount of time and a time until the first communications channel is no longer released. The method can further include the step of selectively converting the second communications channel back to the first communications channel.

In one arrangement, the message can be a notification that a party is attempting to contact at least one of the set of callers. In addition, the message can include information that reveals the identity of the party attempting to contact at least one of the set of callers. The method can further include the steps of terminating the first communications channel after one of the set of callers receives the transmitted message and assigning a third communications channel to permit at least one of the set of callers to contact the party.

As an example, the first communications channel can be a traffic channel, and the second communications channel can be a temporary control channel. Also, both the traffic channel and the temporary control channel can be employed in a trunked dispatch service. In another arrangement, the set of callers can use communications units assigned to the first communications channel to communicate with one another. The first communications channel can be released when none of the communications units that are assigned to the first communications channel are transmitting over the first communications channel.

The present invention also concerns a system for notifying callers. The system includes at least one base station and an application processor. The application processor can assign a first communications channel to a set of callers and can instruct the base station to temporarily convert the first communications channel to a second communications channel when the first communications channel is released. The application processor can also generate a message and can instruct the base station to transmit the message to at least one of the set of callers over the second communications channel. The system can further include suitable software and circuitry for implementing the method described above.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates a telecommunications system in accordance with the inventive arrangements.

FIG. 2 illustrates in greater detail the telecommunications system of FIG. 1 in accordance with the inventive arrangements.

FIG. 3 illustrates a method for notifying callers in accordance with the inventive arrangements.

FIG. 4 illustrates several channels of a wireless communications link in accordance with the inventive arrangements.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward.

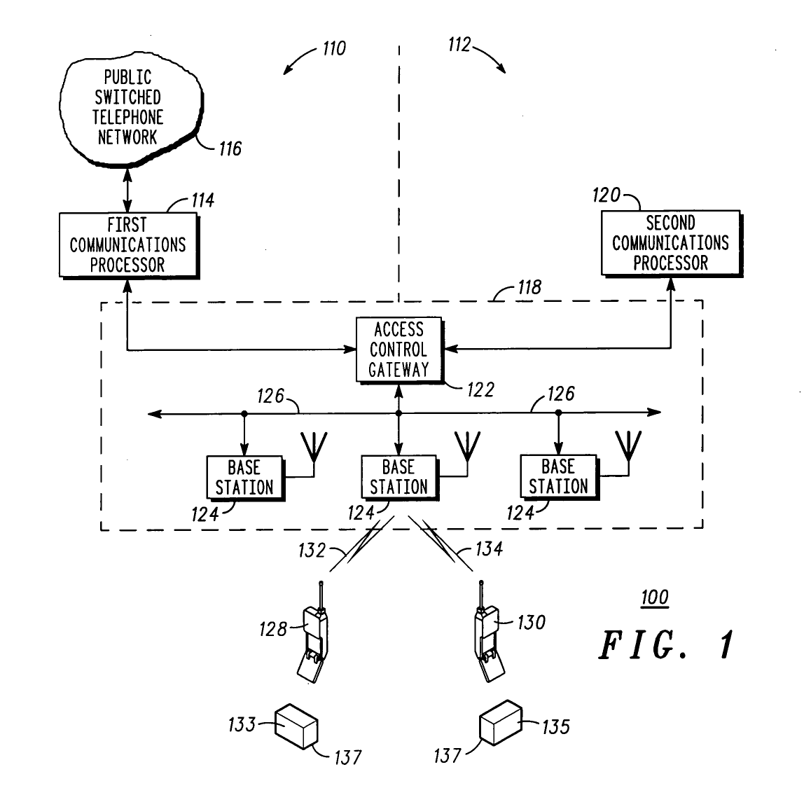

Referring to FIG. 1, a telecommunications system 100 is shown. As an example and without limitation, the system 100 can include both a cellular telephone services portion 110 for supporting cellular telephone services and a trunked dispatch services portion 112 for supporting trunked dispatch services. To support the cellular telephone services, the cellular telephone services portion 110 can include a first communications processor 114, which can be coupled to the public switched telephone network (PSTN) 116 and at least one site 118. The site 118 can include infrastructure that supports wireless communications.

To support the dispatch services, the dispatch services portion 112 can include a second communications processor 120, which can also be coupled to the site 118. As such, both the first communications processor 114 and the second communications processor 120 can share the infrastructure of the site 118 for processing both the cellular telephone and dispatch services. Although such a shared configuration is efficient, it is not necessary for the operation of either of these services. In addition, it is understood that the cellular telephone services portion 110 and the trunked dispatch services portion 112 can be coupled to sites other than or in addition to site 118.

In one arrangement, the site 118 can include one or more access control gateways 122, one or more base stations 124 and one or more buses 126 for coupling the base stations 124 to the access control gateway 122. The base stations 124 can communicate with, for example, a first communications unit 128 over a wireless communications link 132 and with, as another example, a second communications unit 130 over another wireless communications link 134. Continuing with the example, a first user 133 may operate the first communications unit 128, and a second user 135 may operate the second communications unit 130. When the first user 133 is engaged in a call with the second user 135, the first user 133 and the second user 135 can be referred to as a set of callers 137.

Of course, the invention is not limited to this particular example, as the set of callers 137 can include any suitable number of users or members using any suitable number of communications units. Moreover, either of the first communications unit 128 or the second communications unit 130, depending on their location, may be serviced by another site. The first communications unit 128 and the second communications unit 130 may support both cellular telephone service and dispatch service, although the first communications unit 128 and the second communications unit 130 are not limited in this regard. In fact, the term “communications unit” can include any telecommunications unit suitable for conducting a call, including even a fixed telecommunications device.

The access control gateway 122 can include a computational platform having computational capacity and storage sufficient to support the functions described below. In addition, the link between the access control gateway 122 and the first communications processor 114 can be any high-level data link, as defined by the International Standards Organization. In one arrangement, the link between the access control gateway 122 and the second communications processor 120 can be a frame relay link. It is understood, however, that the invention is not limited in this regard, as any other suitable link can be used between the access control gateway 122 and the first communications processor 114 and second communications processor 120.

The base stations 124 can include radio transceivers configured to receive and transmit on appropriate frequencies using suitable modulation and air interface protocols for supporting the requirements of the services being provided. In another arrangement, the bus 126 that couples the base stations 124 to the access control gateway 122 can be an Ethernet link, as well understood in the art.

The operation and configuration of the cellular telephone services portion 110 is well known, and an in-depth discussion is not warranted. Briefly, however, the first communications processor 114 can include a mobile switching center (not shown), a telephone database (not shown) and a base site controller (not shown). As appreciated by those of skill in the art, the mobile switching center can interface with the PSTN 116 and the base site controller. The mobile switching center can also control the provision of cellular telephone service to, for example, the first communications unit 128 and the second communications unit 130, if the first communications unit 128 and the second communications unit 130 support such a service. The telephone database can be coupled to the mobile switching center and can provide to the mobile switching center information concerning the operation of communications units, such as the first communications unit 128 and the second communications unit 130.

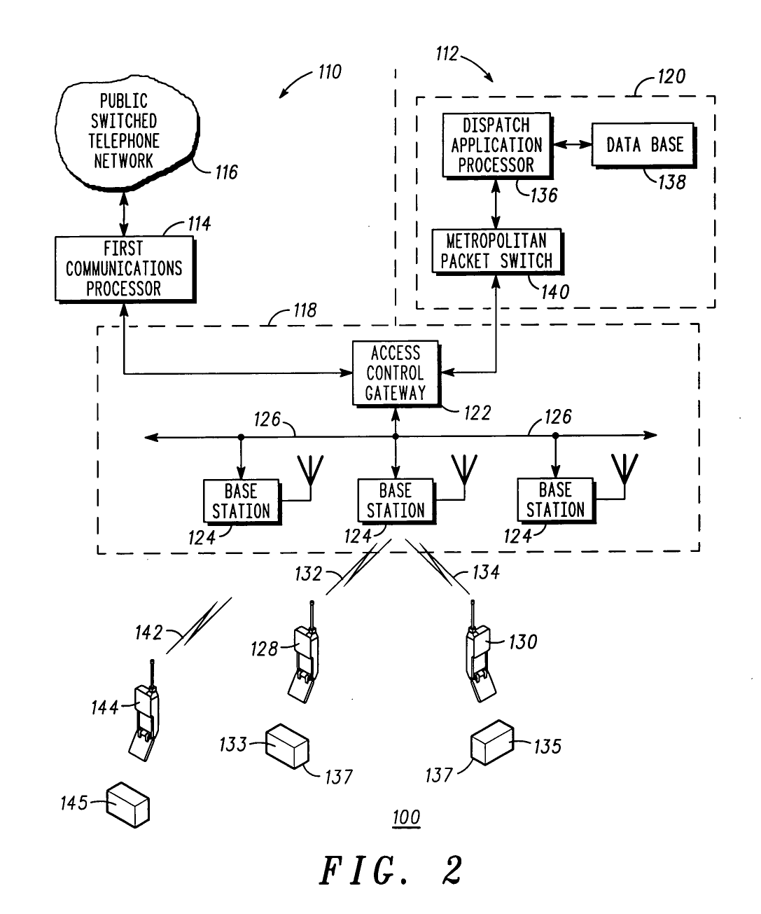

Referring to FIG. 2, the second communications processor 120 can include an application processor such as a dispatch application processor 136, a database 138 coupled to the dispatch application processor 136 and a metropolitan packet switch 140, which can also be coupled to the dispatch application processor 136. Further, dispatch application processor 136 can be coupled to the access control gateway 122 through the metropolitan packet switch 140.

In one arrangement, the dispatch application processor 136 can be programmed to allocate communication resources among dispatch service users and can alert any members in the set of callers 137 that a dispatch call is imminently or presently underway to enable those members of the set of callers 137 to participate in the call. In accordance with the inventive arrangements, the dispatch application processor 136 may also generate a message, such as a call waiting message, and instruct other components of the infrastructure to transmit the message to at least one of the members in the set of callers 137 involved in a dispatch call. This process will be explained later.

As those of ordinary skill in the art will appreciate, the metropolitan packet switch 140 can route audio signals between sites to facilitate the inclusion of the members of the set of callers 137 that are located in other sites that the trunked dispatch services portion 112 serves. The database 138 can include information that relates to the operability status of, for example, the first communications unit 128 and the second communications unit 130, although the database 138 can include information relating to the operability status of any suitable number of communications units. As an example and without limitation, the information stored by the database 138 can include individual identification, group identification, alias information, roaming status and priority information.

In one arrangement, a party 145 using a third communications unit 144, which can communicate with one of the base stations 124 over a wireless communications link 142, may wish to contact, for example, one or more members in the set of callers 137. Those of skill in the art will appreciate that the third communications unit 144 being used by the party 145 may be in contact with a site other than site 118, and hence, a base station other than the base stations 124. In accordance with the inventive arrangements, the components of the dispatch services portion 112, in response to the effort by the party 145 to contact one or more members of the set of callers 137, can notify one or more of these members of this attempt. This process can permit one or more members of the set of callers 137 to be aware of the attempted contact, and in response, such members can engage the party 145 in a call.

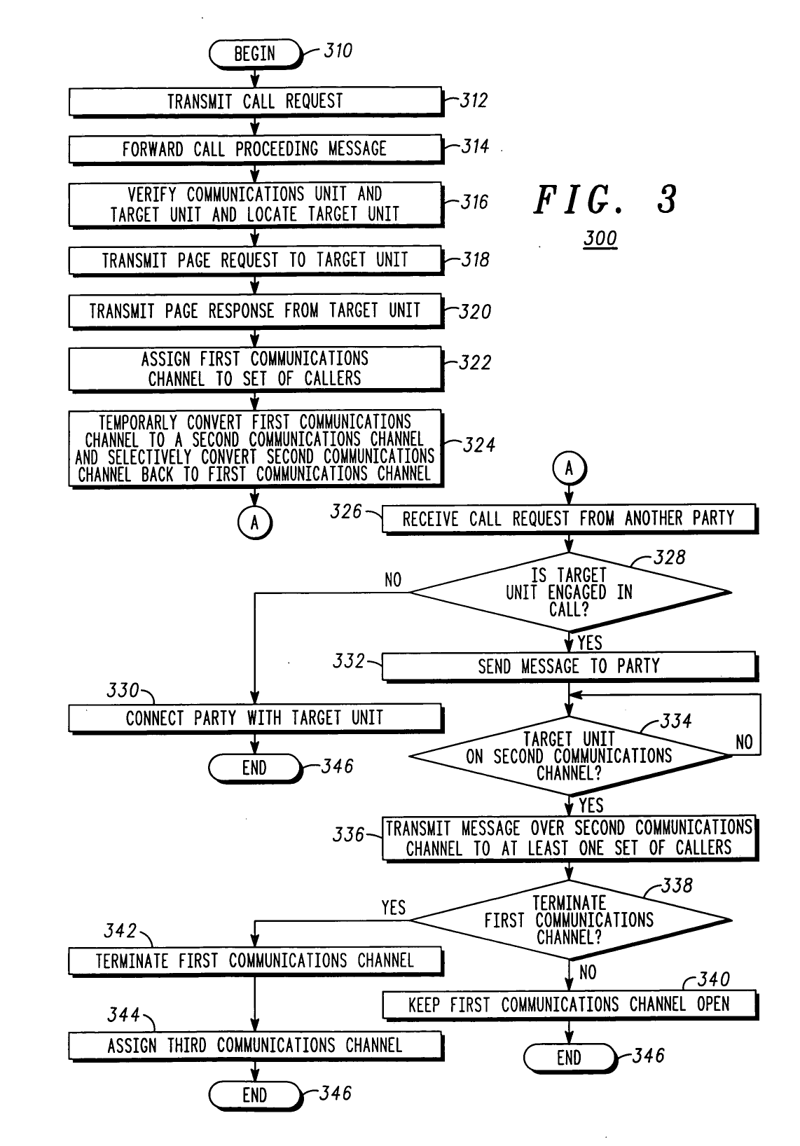

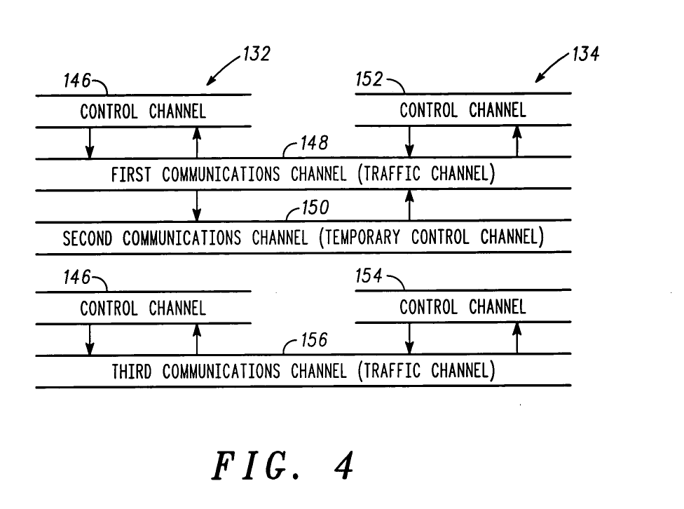

The overall operation of the dispatch services portion 112 of the system 100 in accordance with the inventive arrangements will now be described. Referring to FIG. 3, a method 300 for notifying callers is shown. Reference will be made to FIG. 2 and FIG. 4 (FIG. 4 shows several sets of channels that make up several wireless communications links) when describing the steps of FIG. 3. It is understood, however, that the method 300 is in no way limited to being practiced in the system 100 of FIG. 2, as the method 300 can be implemented into any other suitable telecommunications system.

At step 310, the method 300 can begin. At step 312, a user can cause a call request, such as a dispatch call request, to be transmitted from a communication unit. For example, the first user 133 can cause a dispatch call request to be sent from the first communication unit 128. This call request can travel over a control channel 146 (see FIG. 4), which can be part of the wireless communications link 132, to one of the base stations 124. The base station 124 can transmit the call request to the access control gateway 122, which can forward the call request to the dispatch application processor 136.

During this process, a call proceeding message can be forwarded to the communications unit, as shown at step 314. For example, the access control gateway 122 can transmit through the base station 124 a message to the first communications unit 128 notifying the first user 133 that the call is proceeding. This message can also be transmitted over the control channel 146 of the wireless communications link 132. Subsequently, at step 316, it can be verified that the communications unit that initiated the call request and the communications unit that it is trying to contact, i.e., the target communications unit or target unit, are authorized units. Also, in this step, the target communications unit can be located.

As an example, when the dispatch application processor 136 receives the call request, the dispatch application processor 136 can access the database 138. In this example, the target communications unit can be the second communications unit 130. By accessing the database 138, the dispatch application processor 136 can verify that the first communications unit 128 and the second communication unit 130 are authorized units and can determine the location of the second communications unit 130.

At step 318, a page request can be transmitted to the target communications unit. Continuing with the example, the dispatch application processor 136 can generate the page request, which can be sent to the access control gateway 122, the base station 124 and on to the second communications unit 130 over the wireless communications link 134. Specifically, the page request can be transmitted over a control channel 152 of the wireless communications link 134. It is understood that the target communications unit may be located in an area that is not being serviced by the site that is currently servicing the initiating communications unit. As an example, the second communications unit 130 may be located in an area that is serviced by another site (different from the site 118).

At step 320, in response to the page request, a page response can be transmitted from the target communications unit. For example, the second communications unit 130 can send a page response over the control channel 152 of the wireless communications link 134 to the base station 124. The base station 124 can then forward the page response to the access control gateway 122, which can transmit the signal to the dispatch application processor 136.

Once the page response is received, at step 322, a first communications channel can be assigned to a set of callers. For example, when the dispatch application processor 136 receives the page response from the second communications unit 130, the dispatch application processor 136 can assign a first communications channel 148 (see FIG. 4) over which the first communication unit 128 and the second communications unit 130 can communicate. The first communications channel 148 can also be part of the wireless communication link 132 and the wireless communication link 134. In one arrangement, this first communications channel 148 can be a traffic channel, a channel that is commonly used to carry dispatch communications traffic between communications units that support such a service.

As the communications unit that initiated the call and the target communications unit communicate with one another, the first communications channel 148 can be temporarily converted to a second communications channel 150 (see FIG. 4). Specifically, the first communications channel 148 can be converted to the second communications channel 150 when the first communications channel is released, as shown in step 324. For purposes of the invention, the first communications channel 148 can be released when no communications units that are currently assigned to the first communications channel 148 are transmitting over the first communications channel 148. Conversely, the second communications channel 150 can be selectively converted back to the first communications channel 148, as also shown in step 324.

As an example, the first communications unit 128 and the second communications unit 130 can support dispatch service. Both the first communications unit 128 and the second communications unit 130 can include an initiator (not shown), such as a push-to-talk (PTT) button, for initiating a transmission over the first communications channel 148. For example, when the first user 133 of the first communications unit 128 presses the PTT button (and the first communications channel 148 has been assigned), the first communications unit 128 can begin transmitting over the first communications channel 148 and the first user 133 can speak over the channel 148.

When the first user 133 releases the PTT button, the first communications unit 128 can transmit an end-of-transmission (EOT) message over the first communications channel 148 to the base station 124. At this point, the first communications unit 128 is no longer transmitting over the first communications channel 148, and the channel 148 is released. The base station 124 can relay the EOT message to the dispatch application processor 136 through the access control gateway 122. In response, the dispatch application processor 136 can instruct the base station 124 (through the access control gateway 122) to convert, at least temporarily, the first communications channel 148 to the second communications channel 150. As an example, the second communications channel 150 can be a temporary control channel.

In one arrangement, the transport mechanism used in system 100 can be time division multiple access (TDMA). As is known in the art, a TDMA communications channel can be divided up into time slots in which each time slot has a header called a slot descriptor block (SDB). As is also known in the art, the SDB is a five byte parameter that can provide information to the processor in a communications unit as to the type of channel currently being employed. As such, the base station 124 can manipulate the appropriate number of SDBs to convert the first communications channel 148 (the traffic channel) to the second communications channel 150 (the temporary control channel).

Now that the first communications channel 148 has been released, the second user 135 can press the PTT button of the second communications unit 130, and the second communications unit 130 can transmit an update request (UR) message over the second communications channel 150. The base station 124 receives the UR message and forwards it to the dispatch application processor 136 (through the access control gateway 122).

In response, the dispatch application processor 136 can signal the base station 124 (also through the access control gateway 122) to convert the second communications channel 150 (the temporary control channel) back to the first communications channel 148 (the traffic channel). The conversion is carried out similar to the process described above in which the base station 124 sets the SDBs to the appropriate value for the conversion. At this point, the second communications unit 130 can begin transmitting over the first communications channel 148, and the first communications channel 148 is no longer released.

As thus far explained, the first communications channel 148 can be temporarily converted to the second communications channel 150 until the first communications channel 148 is no longer released. The time that the second communications channel 150 is in place is not necessarily a predetermined time, as the second communications channel 150 can be converted back to the first communications channel 148 when, for example, a user wishes to speak over the channel 148. In another arrangement, however, the first communications channel 148 can be temporarily converted to the second communications channel 150 for a predetermined amount of time.

This predetermined amount of time can be referred to as a hang time. As an example, when the first communications channel 148 is converted to the second communications channel 150, neither the first user 133 nor the second user 135 may wish to make any further transmissions. Once the hang time is exhausted, the dispatch application processor 136 can instruct the base station 124 (through the access control gateway 122) to eliminate the second communications channel 150. Because of this process, the first communications channel 148 is also eliminated, i.e., the first communications channel 148 is no longer converted to the second communications channel 150.

Typically, the hang time is roughly six seconds, although the hang time can be any other suitable duration of time. In accordance with the inventive arrangements, the amount of time that the first communications channel 148 is converted to the second communications channel 150 can be either the amount of time until the first communications channel 148 is no longer released or the predetermined amount of time (the hang time), whichever is shorter in duration.

Referring back to FIGS. 2, 3 and 4, at step 326 (through jump circle A), a call request can be received from another party. For example, the party 145 (also referred to as a third user 145) using the third communications unit 144 may wish to contact one of the set of callers 137, such as the first user 133 or the second user 135 or even both. The first user 133 and the second user 135, however, may be engaged in a dispatch call, and the third user 146 is unable to reach either one.

The third communications unit 144 can transmit the call request from the third user 145 over the wireless communications link 142. The call request can be transmitted over a control channel 154 (see FIG. 4) of the wireless communications link 142 to the base station 124. The base station 124 can then relay the call request to the access control gateway 122, which can forward the call request to the dispatch application processor 136.

At decision block 328, it can be determined whether the user that the party is attempting to contact is engaged in, for example, a dispatch call. If not, at step 330, the party can be connected to the target user in accordance with the discussion above, and the method can end at step 346. Alternatively, if the target user(s) is engaged in a dispatch call, a message can be sent to the party indicating this condition, as shown at step 332.

For example, the third user 145 can attempt to contact the first user 133 and the first user 133 can be engaged in a dispatch call with the second user 135. The dispatch application processor 136 can access the database 138 to determine that the first user 133 is engaged in this call. In response, the dispatch application processor 136 will generate a message indicating that the target user, in this case the first user 133, is not available. The dispatch application processor 136 can signal the access control gateway 122 and the base station 124 to forward this message to the third communications unit 144 over the control channel 154.

At decision block 334, it can be determined whether the target user(s) and the caller with whom the target user is speaking are on the second communications channel 150. If they are not, the method 300 can wait until this set of callers are on the second communications channel 150. If the set of callers are on the second communications channel 150, a message can be transmitted over the second communications channel 150 to at least one of the set of callers, such as the target user, as shown at step 336.

For example, the dispatch application processor 136 can generate a call notification message and can determine when the first user 133 and the second user 135 are on the second communications channel 150 (the temporary control channel). The dispatch application processor 136 can determine when the first user 133 and the second user 135 are on the second communications channel 150 when the dispatch application processor 136 receives an EOT message.

Now that the first communications channel 148 has been converted to the second communications channel 150, the dispatch application processor 136 can transmit the call notification message to the target user, which in this example is the first user 133. That is, the dispatch application processor 136 can transfer the message to the access control gateway 122, which can transmit the message to the base station controller 124, which can forward the message over the second communications channel 150 of the wireless communications link 132 to the first communications unit 128. Because it can be a half-duplex dispatch call, the second communications unit 130 can be on the same frequency as the first communications unit 128. As a result, the second communications unit 130 can also receive the call notification message over the second communications channel 150 of the wireless communications link 134, even if the second communications unit 130 is not a target unit.

In one arrangement, the dispatch application processor 136 can stop transmitting the call notification message when it receives an update request from a communications unit (explained above). This process can prevent the dispatch application processor 136 from continuously transmitting the call notification message over the second communications channel 150. Alternatively, the dispatch application processor 136 can be programmed to stop transmitting the message over the second communications channel 150 after a predetermined amount of time.

The call notification message can be any suitable message that informs a set of callers that a party is attempting to contact at least one of them. In one arrangement, the call notification message can include information that reveals the identity of the party attempting to contact at least one of the set of callers. For example, the first communications unit 128 and the second communications unit 130 can be programmed to display the identity of a caller, such as the third user 145. The identity can be the caller's name or alias and can include the caller's contact number.

Now, at least one of the set of callers, i.e., target user(s), knows that another party is attempting to contact the target user. The target user can determine whether to terminate the first communications channel 148, as shown at decision block 338, in order to contact this party. If the target user does not wish to contact the party, at step 340, the first communications channel 148 can remain open to permit the initial set of callers to continue with their call. The method 300 can stop at step 346.

If the target user wishes to contact the party, however, the target user can terminate the first communications channel 148, as shown at step 342. The target user can initiate a call to the party in a process similar to the operation described in relation to steps 312 through 322, and at step 344, a third communications channel can be assigned to the target user and the party. The method 300 can end at step 346.

For example, the first user 133, because he is the target user, can decide whether he wants to contact the third user 145. If so, the first user 133 can terminate the call that is currently taking place on the first communications channel 148 with the second user 135. This step terminates the first communications channel 148 (and the second communications channel 150 as well). The first user 133 can then initiate another call in accordance with the above discussion to contact the third user 145, and the dispatch application processor 136 can assign a third communications channel 156 to the first user 133 and the third user 145. Alternatively, the first user 133 can ignore the call notification message and can continue speaking with the second user 135 over the first communications channel 148.

In accordance with the inventive arrangements, a target user engaged in a dispatch call can be notified when another party not on the call is attempting to contact the target user. It must be noted, however, that the foregoing examples are merely meant to illustrate the operation of the invention. The invention is in no way limited to the system 100 that has been described, as the invention can be practiced in any other suitable communications arrangement. Moreover, the invention is not limited to the particular embodiment in which two callers are engaged in a dispatch call and a third party is attempting to contact one of the two callers, as the invention envisions any suitable number of parties attempting to contact any suitable number of callers engaged in any type of call.

In addition, while the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

1. A method for notifying callers, comprising the steps of:
assigning a first communications channel to a set of callers;
temporarily converting the first communications channel to a second communications channel when the first communications channel is released; and
transmitting a message to at least one of the set of callers over the second communications channel.

2. The method according to claim 1, wherein the first communications channel is converted to the second communications channel for the shorter duration of a predetermined amount of time and a time until the first communications channel is no longer released.

3. The method according to claim 2, further comprising the step of selectively converting the second communications channel back to the first communications channel.

4. The method according to claim 1, wherein the message is a notification that a party is attempting to contact at least one of the set of callers.

5. The method according to claim 4, wherein the message includes information that reveals the identity of the party attempting to contact at least one of the set of callers.

6. The method according to claim 4, further comprising the steps of:
terminating the first communications channel after one of the set of callers receives the transmitted message; and
assigning a third communications channel to permit at least one of the set of callers to contact the party.

7. The method according to claim 1, wherein the first communications channel is a traffic channel and the second communications channel is a temporary control channel, both the traffic channel and the temporary control channel being employed in a trunked dispatch service.

8. The method according to claim 1, wherein the set of callers use communications units assigned to the first communications channel to communicate with one another and wherein the first communications channel is released when none of the communications units that are assigned to the first communications channel are transmitting over the first communications channel.

9. A method of notifying callers, comprising the steps of:
assigning a first communications channel to a set of callers;
temporarily converting the first communications channel to a second communications channel when the first communications channel is released; and
transmitting over the second communications channel to at least one of the set of callers a notification that a party is attempting to contact at least one of the set of callers;
wherein the first communications channel and the second communications channel are employed in a trunked dispatch service.

10. A system for notifying callers, comprising:
at least one base station; and
an application processor, wherein said application processor assigns a first communications channel to a set of callers and instructs said base station to temporarily convert said first communications channel to a second communications channel when said first communications channel is released;
wherein said application processor generates a message and instructs said base station to transmit said message to at least one of the set of callers over said second communications channel.

11. The system according to claim 10, wherein said application processor instructs said base station to convert said first communications channel to said second communications channel for the shorter duration of a predetermined amount of time and a time until said first communications channel is no longer released.

12. The system according to claim 11, wherein application processor instructs said base station to selectively convert said second communications channel back to said first communications channel.

13. The system according to claim 10, wherein said message is a notification that a party is attempting to contact at least one of the set of callers.

14. The system according to claim 13, wherein said message includes information that reveals the identity of the party attempting to contact at least one of the set of callers.

15. The system according to claim 13, wherein said application processor terminates said first communications channel after one of the set of callers receives said transmitted message and assigns a third communications channel to permit at least one of the set of callers to contact the party.

16. The system according to claim 10, wherein said first communications channel is a traffic channel and said second communications channel is a temporary control channel, both said traffic channel and said temporary control channel being employed in a trunked dispatch service.

17. The system according to claim 10, further comprising at least one communications unit assigned to said first communications channel, wherein the set of callers use said communications units to communicate with one another and wherein said first communications channel is released when none of said communications units that are assigned to said first communications channel are transmitting over said first communications channel.
